(19) United States
(12) Patent Application Publication
(10) Pub. No.: US 2025/0077834 A1
(43) Pub. Date: Mar. 6, 2025

(54) In-Memory Deep Neural Network Device Using Spin Orbit Torque (SOT) With Multi-State Weight

(71) Applicant: Western Digital Technologies, Inc., San Jose, CA (US)

(72) Inventors: Quang LE, San Jose, CA (US); Xiaoyong LIU, San Jose, CA (US); Lei XU, San Jose, CA (US); Brian R. YORK, San Jose, CA (US); Cherngye HWANG, San Jose, CA (US); Hisashi TAKANO, Fujisawa-shi (JP)

(73) Assignee: Western Digital Technologies, Inc., San Jose, CA (US)

(21) Appl. No.: 18/954,415

(22) Filed: Nov. 20, 2024

Related U.S. Application Data
(63) Continuation-in-part of application No. 17/172,155, filed on Feb. 10, 2021.

(51) Int. Cl. G06N 3/04

(52) U.S. Cl. CPC G06N 3/04

(57) ABSTRACT

The present disclosure is generally related to a deep neural network (DNN) device comprising a plurality of spin-orbit torque (SOT) cells. The DNN device comprises an array comprising n rows and m columns of nodes, each row of nodes coupled to one of n first conductive lines, each column of nodes coupled to one of m second conductive lines, each node of the n rows and m columns of nodes comprising a plurality of SOT cells, each SOT cell comprising: at least one SOT layer, at least one ferromagnetic (FM) layer, and a controller configured to store at least one corresponding weight of an n×m array of weights of a neural network in each of the SOT cell. The FM layer may comprise two or more domains, two or more elliptical arms, or two or more states.

### CROSS-REFERENCE TO RELATED APPLICATIONS

This application is a continuation-in-part of co-pending U.S. patent application Ser. No. 17/172,155, filed Feb. 10, 2021, which is herein incorporated by reference.

### BACKGROUND OF THE DISCLOSURE

### Field of the Disclosure

Embodiments of the present disclosure generally relate to a deep neural network (DNN) device utilizing a plurality of spin-orbit torque (SOT) cells.

### Description of the Related Art

Deep neural networks (DNNs) are a promising and quickly evolving area of technology utilized in artificial intelligence (AI). DNNs are composed of multiple layers (two or more) between the input and final output layers. DNNs transform data at each layer, creating a new representation of each layer output. Generally, when a DNN is under training, many of its parameter weights are updated, and during inference, the DNN's parameter weights are already fixed by pre-training. When DNNs are used for inference, the states/values of weights are known. In implementations where non-volatile memory cells are configured for DNN applications with weights stored in the cells, the amount and magnitude of current needed to set or read the states from the cells is known as well.

A core feature of many DNNs involves matrix multiplication/summation followed by an activation function (e.g., a non-linear transfer function). Many DNNs currently rely solely on a traditional computing architecture with discrete memory and processor components to perform both the matrix multiplication/summation and the activation function. Traditional computing architecture-based implementations of a DNN generally require more data movement between a main memory and a CPU/GPU, which is more power/memory consuming and slower. Hardware compute-in-memory implementations of DNNs promise lower energy, non-linearity, and higher density for AI applications. However, the current compute-in-memory hardware implementations of DNN are still limited.

Therefore, there is a need in the art for new hardware implementations for DNNs for inference.

### SUMMARY OF THE DISCLOSURE

The present disclosure is generally related to a deep neural network (DNN) device comprising a plurality of spin-orbit torque (SOT) cells. The DNN device comprises an array comprising n rows and m columns of nodes, each row of nodes coupled to one of n first conductive lines, each column of nodes coupled to one of m second conductive lines, each node of the n rows and m columns of nodes comprising a plurality of SOT cells, each SOT cell comprising: at least one SOT layer, at least one ferromagnetic (FM) layer, and a controller configured to store at least one corresponding weight of an n×m array of weights of a neural network in each of the SOT cell. The FM layer may comprise two or more domains, two or more elliptical arms, or two or more states.

In one embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT), each SOT cell comprising: a SOT layer, a ferromagnetic (FM) layer disposed on the SOT layer, the FM layer being configured with a plurality of domain walls, electrodes disposed adjacent to the SOT layer, the electrodes being spaced from the FM layer, and a first current line configured to apply current through a first electrode of the electrodes, to the SOT layer, to a second electrode of the electrodes, and a controller configured to store at least one corresponding weight of an n×m array of weights of a neural network in each of the SOT cell.

In another embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT) cells, each SOT cell comprising: a first ferromagnetic (FM) layer, a SOT layer disposed on the first FM layer, a second FM layer disposed on the SOT layer, and electrodes disposed adjacent to the SOT layer, the electrodes being spaced from the first and second FM layers, and a controller configured to store at least one corresponding weight of an n×m array of weights of a neural network in each of the SOT cell.

In yet another embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT) cells, each SOT cell comprising: a first SOT layer, a first ferromagnetic (FM) layer disposed on the first SOT layer, the first FM layer having a multi-elliptical shape creating two or more magnetic states at two or more corners or two or more arms formed by the multi-elliptical shape, and a current input configured to apply current through: a first current path across the first SOT layer and a second current path across the first SOT layer, and a controller configured to store at least one corresponding weight of an n×m array of weights of a neural network in each of the SOT cell.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A depicts an embodiment of a memory system and a host.

FIG. 1B depicts an embodiment of memory core control circuits.

FIG. 1C depicts further details of one embodiment of voltage generators.

FIG. 2A shows an example of an artificial neural network.

FIG. 2B depicts a matrix-vector multiplication operation of the artificial neural network of FIG. 2A.

FIG. 2C depicts an embodiment of an apparatus that may be used to perform the matrix-vector multiplication operation depicted in FIG. 2B.

FIG. 3A depicts an embodiment of a cross-point memory array that may be used to perform the matrix-vector multiplication operation depicted in FIG. 2B.

FIG. 3B1 depicts an example spin-orbit torque (SOT) magnetoresistive random-access memory (MRAM) non-volatile memory cell of the apparatus of FIG. 3A.

FIG. 3B2 depicts another example SOT MRAM non-volatile memory cell of the apparatus of FIG. 3A.

FIG. 3C depicts another example SOT MRAM non-volatile memory cell of the apparatus of FIG. 3A.

FIGS. 4A-4C illustrate cross-sectional views of SOT cells that may be included in the non-volatile memory array of FIGS. 3A and 4D, according to various embodiments.

FIG. 4D depicts another embodiment of a cross-point memory array that may be used to perform the matrix-vector multiplication operation depicted in FIG. 2B.

FIGS. 5A-5D illustrate top views of FM layers that may be utilized in the SOT cells of FIGS. 3B1, 3B2 and 3C and 4A-4C, according to various embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure is generally related to a deep neural network (DNN) device comprising a plurality of spin-orbit torque (SOT) cells for inference. The DNN device comprises an array comprising n rows and m columns of nodes, each row of nodes coupled to one of n first conductive lines, each column of nodes coupled to one of m second conductive lines, each node of the n rows and m columns of nodes comprising a plurality of SOT cells, each SOT cell comprising: at least one SOT layer, at least one ferromagnetic (FM) layer, and a controller configured to store at least one corresponding weight of an n×m array of weights of a neural network in each of the SOT cell. The FM layer may comprise two or more domains, two or more elliptical arms, or two or more states.

Technology is described for using non-volatile memory cells to perform matrix multiplication in deep neural networks (DNNs). In particular, technology is described for using spin-orbit torque (SOT) non-volatile memory cells to perform matrix-vector multiplication in a neuromorphic computing system. A neuromorphic computing system may be used to implement an artificial neural network.

Matrix-vector multiplication may be performed by taking the dot product of a vector with each column vector of a matrix. A vector dot product is the sum of products of the corresponding elements of two equal length vectors. Accordingly, a non-volatile memory system that performs matrix-vector multiplication also may be referred to as a multiplier-accumulator (MAC).

In an embodiment, a non-volatile memory system includes an array that includes n rows and m columns of nodes, with each node including a non-volatile memory cell. In this regard, the array is an n×m array of non-volatile memory cells. In an embodiment, each row of nodes is coupled to one of n first conductive lines (e.g., word lines), and each column of nodes is coupled to one of m second conductive lines (e.g., bit lines).

In an embodiment, each non-volatile memory cell includes an SOT non-volatile memory cell. Thus, in an embodiment each row of SOT non-volatile memory cells is coupled to one of n first conductive lines (e.g., word lines), and each column of SOT non-volatile memory cells is coupled to one of m second conductive lines (e.g., bit lines).

As used herein, the value of a weight stored in an SOT non-volatile memory cell is also referred to herein as a “multiplicand.” While in some approaches each SOT non-volatile memory cell can be a “binary non-volatile memory cell,” which is a non-volatile memory cell that can be repeatedly switched between two physical states, embodiments disclosed herein are directed to multi-state non-volatile memory cells, which are non-volatile memory cells that may be repeatedly switched among more than two physical states.

In binary weight DNN implementations, each memory cell in the n×m array of SOT non-volatile memory cells is configured to store one bit of information. In such cases, each SOT non-volatile memory cell may be programmed to either a low resistance state (also referred to herein as an “ON state”) or a high resistance state (also referred to herein as an “OFF-state”). The low resistance state may be used to represent the first weight value (e.g., “1”), and the high resistance state may be used to represent the second weight value (e.g., “0”). In contrast, multi-state weight cells of the disclosed embodiments can have more than two weight values.

In an embodiment, n input voltages (also referred to herein as “multiply voltages”) are applied to the first conductive lines (e.g., word lines). In an embodiment, each of the n multiply voltages represents a single-bit binary input, and has either a first input value (e.g., “1V”) or a second input value (e.g., “0V”). Other binary voltage values may be used for first input value and second input value. In an embodiment, the n multiply voltages constitute an n-element input vector (also referred to herein as a “multiply vector”).

In an embodiment, the memory cells in the n×m array of SOT non-volatile memory cells generate m output currents at the m second conductive lines (e.g., bit lines). In an embodiment, the m output currents constitute a result of multiplying the n-element input vector (multiply vector) by the n×m array of weights stored in the SOT non-volatile memory cells, where the weights can be more than two states. In an embodiment, each of the m output currents provides an output that can go beyond a binary output, since there are output values representing multiple discrete weights. In an embodiment, the m output currents constitute an m-element output vector.

In this regard, multiplication is performed by applying a multiply voltage to a node and processing a current from the SOT non-volatile memory cell in the node. In an embodiment, each multiply voltage has a magnitude that represents a multiplier. In an embodiment, the multiply voltage is applied across two terminals of the SOT non-volatile memory cell.

In an embodiment, the SOT non-volatile memory cell responds to the multiply voltage by conducting a memory cell current in the second conductive line (e.g., bit line) coupled to the SOT non-volatile memory cell. The magnitude of the memory cell current represents a product of the multiplier applied to the node and the multiplicand stored in the SOT non-volatile memory cell in the node.

As described above, in an embodiment each SOT non-volatile memory cell may be programmed to multiple states beyond a low resistance ON-state or a high resistance OFF-state, and each of the n multiply voltages has either a first input value (e.g., “1V”) or a second input value (e.g., “0V”). As a result, each of the m output currents represents an output that can go beyond a binary output and has an output that represents the multiplication of the multiply input voltage and the multiple weight states in the cell.

As used herein, “multiplier” is used for the magnitude of the multiply voltage, and “multiplicand” is used for the value of the weight stored in the SOT non-volatile memory cell in the node. This is for the convenience of discussion. The terms “multiplier” and “multiplicand” are interchangeable.

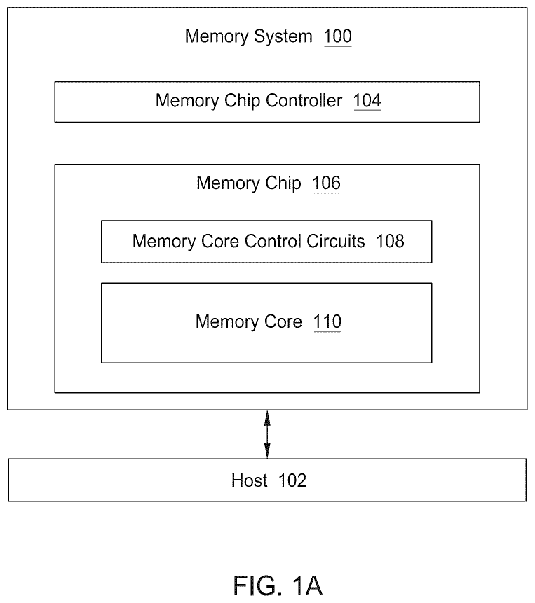

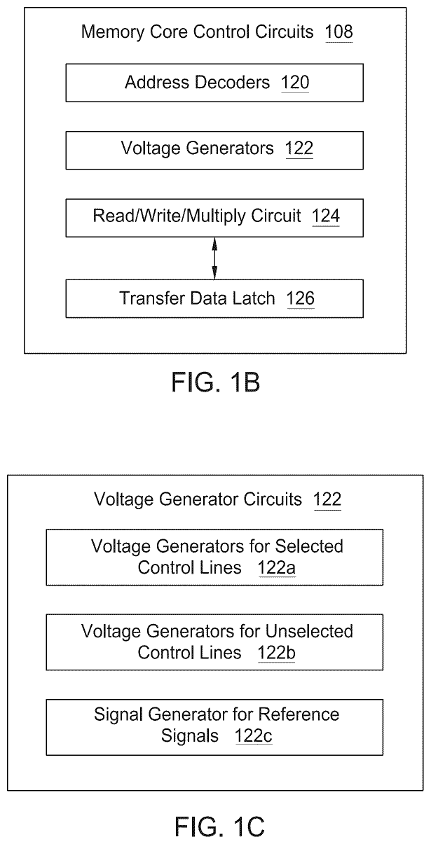

An example memory system 100 in which embodiments may be practiced will be discussed. FIG. 1A depicts an embodiment of a memory system 100 and a host 102. Memory system 100 may include a non-volatile storage system interfacing with host 102 (e.g., a mobile computing device). In some cases, memory system 100 may be embedded within host 102. In other cases, memory system 100 may include a memory card.

As depicted, memory system 100 includes a memory chip controller 104 and a memory chip 106. Although a single memory chip 106 is depicted, memory system 100 may include more than one memory chip (e.g., four, eight or some other number of memory chips). Memory chip controller 104 may receive data and commands from host 102 and provide data to host 102. In an embodiment, memory system 100 is used to perform matrix-vector multiplication. In an embodiment, memory system 100 is used to perform matrix-vector multiplication in a neuromorphic computing system.

Memory chip controller 104 may include one or more state machines, page registers, SRAM, decoders, sense amplifiers, and control circuitry for controlling the operation of memory chip 106. The one or more state machines, page registers, SRAM, and control circuitry for controlling the operation of memory chip 106 may be referred to as managing or control circuits.

The managing or control circuits may facilitate one or more memory operations, such as programming, reading (or sensing) and erasing operations. In an embodiment, the managing or control circuits are used to perform multiplication using non-volatile memory cells. Herein, multiplication will be referred to as a type of memory operation.

In some embodiments, the managing or control circuits (or a portion of the managing or control circuits) that facilitate one or more memory array operations, including programming, reading, erasing and multiplication operations, may be integrated within memory chip 106. In some embodiments, the managing or control circuits may include an on-chip memory controller for determining row and column address, bit line, source line and word line addresses, memory array enable signals, and data latching signals.

Memory chip controller 104 and memory chip 106 may be arranged on a single integrated circuit. In other embodiments, memory chip controller 104 and memory chip 106 may be arranged on different integrated circuits. In some cases, memory chip controller 104 and memory chip 106 may be integrated on a system board, logic board, or a PCB.

Memory chip 106 includes memory core control circuits 108 and a memory core 110. In an embodiment, memory core control circuits 108 include circuits that generate row and column addresses for selecting memory blocks (or arrays) within memory core 110, and generating voltages to bias a particular memory array into a read or a write state. In an embodiment, memory core control circuits 108 include circuits for generating voltages to bias a memory array to perform matrix-vector multiplication using non-volatile memory cells in memory core 110.

Memory chip controller 104 controls operation of memory chip 106. In an embodiment, once memory chip controller 104 initiates a memory operation (e.g., read, write, or multiply), memory core control circuits 108 generate the appropriate bias voltages for bit lines, source lines and/or word lines within memory core 110, and generates the appropriate memory block, row, and column addresses to perform memory operations.

In an embodiment, memory core 110 includes one or more arrays of non-volatile memory cells used to perform matrix-vector multiplication. In an embodiment, memory core 110 includes one or more arrays of SOT non-volatile memory cells used to perform matrix-vector multiplication in a neuromorphic computing system. Memory core 110 may include one or more two-dimensional or three-dimensional arrays of SOT non-volatile memory cells.

In an embodiment, memory core control circuits 108 and memory core 110 are arranged on a single integrated circuit. In other embodiments, memory core control circuits 108 (or a portion of memory core control circuits 108) and memory core 110 may be arranged on different integrated circuits.

In an embodiment, memory core 110 includes a three-dimensional memory array of SOT non-volatile memory cells in which multiple memory levels are formed above a single substrate, such as a wafer. The memory structure may include SOT non-volatile memory that is monolithically formed in one or more physical levels of arrays of non-volatile memory cells having an active area disposed above a silicon (or other type of) substrate.

FIG. 1B depicts an embodiment of memory core control circuits 108. As depicted, memory core control circuits 108 include address decoders 120, voltage generators 122, read/write/multiply circuit 124, and transfer data latch 126. In an embodiment, address decoders 120 generate memory block addresses, as well as row addresses and column addresses for a particular memory block. In an embodiment, voltage generators (or voltage regulators) 122 generate voltages for control lines.

Read/write/multiply circuit 124 includes circuitry for reading and writing non-volatile memory cells in memory core 110. In an embodiment, transfer data latch 126 is used for intermediate storage between memory chip controller 104 (FIG. 1A) and non-volatile memory cells. In an embodiment, transfer data latch 126 has a size equal to a size of a page.

In an embodiment, when host 102 instructs memory chip controller 104 to write data to memory chip 106, memory chip controller 104 writes a page of host data to transfer data latch 126. Read/write/multiply circuit 124 then writes data from transfer data latch 126 to a specified page of non-volatile memory cells.

In an embodiment, when host 102 instructs memory chip controller 104 to read data from memory chip 106, read/write/multiply circuit 124 reads from a specified page of non-volatile memory cells into transfer data latch 126, and memory chip controller 104 transfers the read data from transfer data latch 126 to host 102.

Read/write/multiply circuit 124 also includes circuitry for performing multiplication operations using non-volatile memory cells. In an embodiment, read/write/multiply circuit 124 stores multiplicands (e.g., weights) in the non-volatile memory cells.

In an embodiment, read/write/multiply circuit 124 is configured to apply multiply voltages to SOT non-volatile memory cells that store multiplicands (e.g., weights). As described above, in an embodiment each multiply voltage has a magnitude that represents a multiplier. In an embodiment, the non-volatile memory cell in a node conducts a memory cell current in response to the multiply voltage applied to the non-volatile memory cell. In an embodiment, the magnitude of the non-volatile memory cell output current depends on the physical state of the non-volatile memory cell and the magnitude of the multiply voltage.

For example, in an embodiment the magnitude of a SOT non-volatile memory cell current depends on the resistance or other magnetization status of the SOT non-volatile memory cell and the voltage applied across two terminals of the SOT non-volatile memory cell. In an embodiment, the magnitude of the non-volatile memory cell current depends on the non-volatile memory cell's weight state.

The multiply voltage may be similar in magnitude to a read voltage, in that the multiply voltage may cause the SOT non-volatile memory cell to conduct a memory cell current without changing the physical state of the SOT non-volatile memory cell. However, whereas a read voltage may have a magnitude that is selected to delineate between physical states, the magnitude of a multiply voltage is not necessarily selected to delineate between physical states. The following examples of a SOT non-volatile memory cell programmed to one of two states will be used to illustrate the basic concept, though the various embodiments provide for the cells being programmed to store more than two states.

In a read operation, after a read voltage is applied the SOT memory cell current may be sensed and compared with a reference current to determine which state the memory cell is in. For example, the magnitude of the output current corresponding to the read voltage may be compared to a reference current to delineate between the two states. However, the multiply voltage could have one of many different magnitudes, depending on what multiplier is desired. Moreover, the memory cell current that results from applying the multiply voltage is not necessarily compared to a reference current.

In an embodiment, read/write/multiply circuit 124 simultaneously applies a corresponding multiply voltage to each node. Each multiply voltage may correspond to an element of an input vector. The current in each bit line generates a vector multiplication result signal that represents multiplication of the first vector by a second vector.

FIG. 1C depicts further details of an embodiment of voltage generator circuits 122, which includes voltage generators for selected control lines 122a, voltage generators for unselected control lines 122b, and signal generators for reference signals 122c. Control lines may include bit lines, source lines and word lines, or a combination of bit lines, source lines and word lines.

Voltage generators for selected control lines 122a may be used to generate program, read, and/or multiply voltages. In an embodiment, voltage generators for selected control lines 122a generates a voltage whose magnitude is based on a multiplier for a mathematical multiplication operation. In an embodiment, the voltage difference between the voltages for two selected control lines is a multiply voltage.

Voltage generators for unselected control lines 122b may be used to generate voltages for control lines that are connected to memory cells that are not selected for a program, read, or multiply operation. Signal generators for reference signals 122c may be used to generate reference signals (e.g., currents, voltages) to be used as a comparison signal to determine the physical state of a memory cell.

In an embodiment, non-volatile memory cells are used to perform matrix-vector multiplication in a neuromorphic computing system. A neuromorphic computing system may be used to implement an artificial neural network.

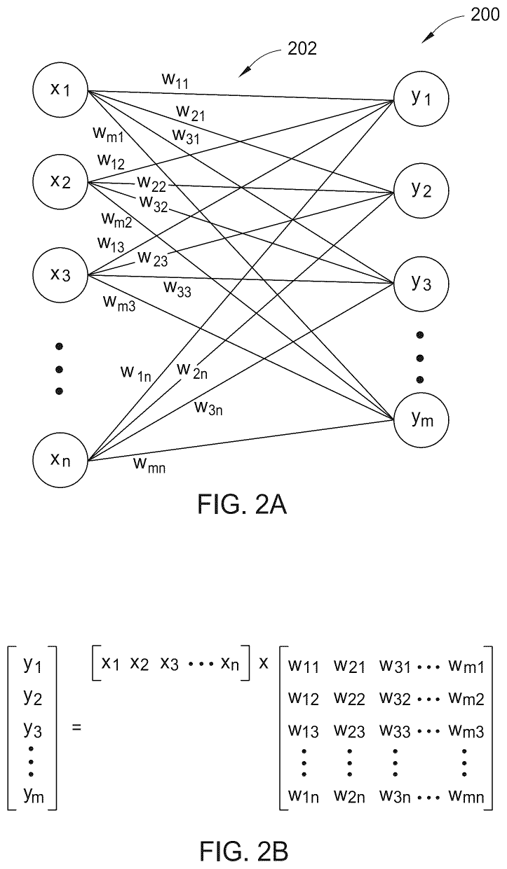

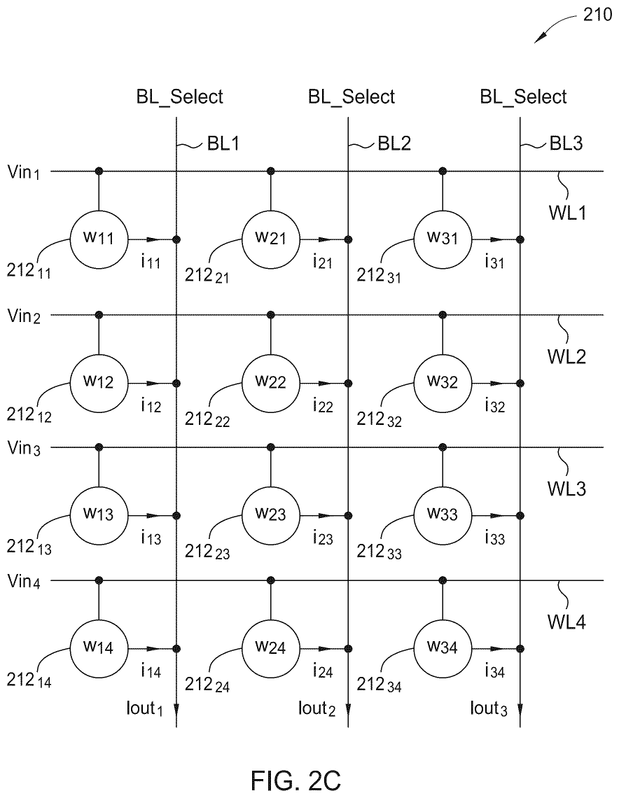

FIG. 2A depicts an example of an artificial neural network or DNN 200 that includes input neurons x₁, x₂, x₃, . . . , xₙ, output neurons y₁, y₂, y₃, . . . , yₘ, and synapses 202 that connect input neurons x₁, x₂, x₃, . . . , xₙ to output neurons y₁, y₂, y₃, . . . , yₘ. In an embodiment, each synapse 202 has a corresponding weight w₁₁, w₁₂, w₁₃, . . . , wₙₘ.

In an embodiment, each input neuron x₁, x₂, x₃, . . . , xₙ has an associated value, each output neuron y₁, y₂, y₃, . . . , yₘ has an associated value, and each weight w₁₁, w₁₂, w₁₃, . . . , wₙₘ has an associated value. The value of each output neuron y₁, y₂, y₃, . . . , yₘ may be determined as follows:

$${y}_{k} = {\sum }_{j = 1}^{n} {x}_{j} {w}_{kj} , \qquad ( 1 )$$

$$k = 1 , 2 , … , m$$

In matrix notation, equation (1) may be written as y=x^{T}W, where y is an m-element output vector, x is an n-element input vector, and W is an n×m array of weights, as depicted in FIG. 2B.

The matrix-vector multiplication operation depicted in FIG. 2B may be implemented by multiply and accumulate operations, in which each output neuron y₁, y₂, y₃, . . . , yₘ has an associated value equal to the sum of products of each input neuron x₁, x₂, x₃, . . . , xₙ with the corresponding weight w₁₁, w₁₂, w₁₃, . . . , wₙₘ that connects each respective input neuron x₁, x₂, x₃, . . . , xₙ to the output neuron y₁, y₂, y₃, . . . , yₘ.

So, for example, with n=4 and m=3,

$${y}_{1} = {x}_{1} {w}_{11} + {x}_{2} {w}_{12} + {x}_{3} {w}_{13} + {x}_{4} {w}_{14} \qquad ( 2 )$$

$${y}_{2} = {x}_{1} {w}_{21} + {x}_{2} {w}_{22} + {x}_{3} {w}_{23} + {x}_{4} {w}_{24} \qquad ( 3 )$$

$${y}_{3} = {x}_{1} {w}_{31} + {x}_{2} {w}_{32} + {x}_{3} {w}_{33} + {x}_{4} {w}_{34} \qquad ( 4 )$$

In an embodiment, a cross-point memory array is used to perform the multiply and accumulate operations described above. FIG. 2C depicts an example cross-point memory array 210 that may be used to perform the matrix-vector multiplication operation depicted in FIG. 2B, with n=4 and m=3.

Cross-point memory array 210 includes n rows and m columns of nodes 212₁₁, 212₁₂, . . . , 212₃₄. Each row of nodes 212₁₁, 212₁₂, . . . , 212₃₄ is coupled to one of n first conductive lines (e.g., word lines (WL1, WL2, WL3, WL4). Each column of nodes 212₁₁, 212₁₂, . . . , 212₃₄ is coupled to one of m second conductive lines (e.g., bit lines BL1, BL2, BL3). Persons of ordinary skill in the art will understand that cross-point memory arrays may include more or fewer that four word lines, and more or fewer than three bit lines, and more or fewer than twelve nodes.

In an embodiment, each node 212₁₁, 212₁₂, . . . , 212₃₄ of cross-point memory array 210 includes a non-volatile memory cell having an adjustable resistance. In an embodiment, the non-volatile memory cells in nodes 212₁₁, 212₁₂, . . . , 212₃₄ may be programmed to store a corresponding weight or state of an n×m array of weights w₁₁, w₁₂, w₁₃, . . . , w₃₄, respectively. Thus, each node 212₁₁, 212₁₂, . . . , 212₃₄ is labeled with a corresponding weight w₁₁, w₁₂, w₁₃, . . . , w₃₄, respectively, programmed in the corresponding non-volatile memory cell of the node. In an embodiment, each weight w₁₁, w₁₂, w₁₃, . . . , w₃₄ corresponds to a conductance of the non-volatile memory cell in each node 212₁₁, 212₁₂, . . . , 212₃₄, respectively. The weights may be programmed, for example, during a training phase of the neural network. A common training method involves the weights being selectively and/or iteratively updated using an algorithm such as back propagation.

Input voltages Vin₁, Vin₂, Vin₃ and Vin₄ are shown applied to word lines WL1, WL2, WL3, WL4, respectively. The magnitudes of input voltages Vin₁, Vin₂, Vin₃ and Vin₄ correspond to the associated values of input neurons x₁, x₂, x₃ and x₄, respectively. A bit line select voltage (BL_Select) is applied to each bit line to select that bit line. For ease of explanation, it will be assumed that BL_Select is zero volts, such that the voltage across the non-volatile memory cell in each node 212₁₁, 212₁₂, . . . , 212₃₄ is the word line voltage.

In an embodiment, the non-volatile memory cells in nodes 212₁₁, 212₁₂, . . . , 212₃₄ conduct currents i₁₁, i₁₂, . . . , i₃₄, respectively. Each of currents i₁₁, i₁₂, . . . , i₃₄ is based on the voltage applied to the corresponding non-volatile memory cell and the conductance of the corresponding non-volatile memory cell in the node. This “memory cell current” flows to the bit line connected to the non-volatile memory cell. The memory cell current may be determined by multiplying the word line voltage by the conductance of the non-volatile memory cell.

Stated another way, each non-volatile memory cell current corresponds to the result of multiplying one of the elements of an input vector by the weight stored in the non-volatile memory cell. So, for example, the non-volatile memory cell in node 212₁₁ conducts a current i₁₁ that corresponds to the product Vin₁×w₁₁, the non-volatile memory cell in node 212₁₂ conducts a current 12 that corresponds to the product Vin₂×w₁₂, the non-volatile memory cell in node 212₂₃ conducts a current i₂₃ that corresponds to the product Vin₃×w₂₃, and so on.

Bit lines BL1, BL2, BL3 conduct bit line currents Iout₁, Iout₂, Iout₃, respectively. Each bit line current is the summation of the currents of the memory cells connected to that bit line. For example, bit line current Iout₁=i₁₁+i₁₂+i₁₃+i₁₄, bit line current Iout₂=i₂₁+i₂₂+i₂₃+i₂₄, and bit line current Iout₃=i₃₁+i₃₂+i₃₃+i₃₄. Thus, each bit line current Iout₁, Iout₂, Iout₃ may be viewed as representing a sum of products of the input vector with corresponding weights in a column of the n×m array of weights:

$${Iout}_{1} = {Vin}_{1} \times {w}_{11} + {Vin}_{2} \times {w}_{12} + {Vin}_{3} \times {w}_{13} + {Vin}_{4} \times {w}_{14} \qquad ( 5 )$$

$${Iout}_{2} = {Vin}_{1} \times {w}_{21} + {Vin}_{2} \times {w}_{22} + {Vin}_{3} \times {w}_{23} + {Vin}_{4} \times {w}_{24} \qquad ( 6 )$$

$${Iout}_{3} = {Vin}_{1} \times {w}_{31} + {Vin}_{2} \times {w}_{32} + {Vin}_{3} \times {w}_{33} + {Vin}_{4} \times {w}_{34} \qquad ( 7 )$$

The magnitudes of bit line currents Iout1, Iout2 and Iout3 constitute elements of an output vector, and correspond to the associated values of output neurons y₁, y₂ and y₃, respectively and constitute the result of the matrix-vector multiplication operation depicted in FIG. 2B. As further discussed below, a separate circuitry (e.g., sense amplifier) takes the current outputs and performs the activation function.

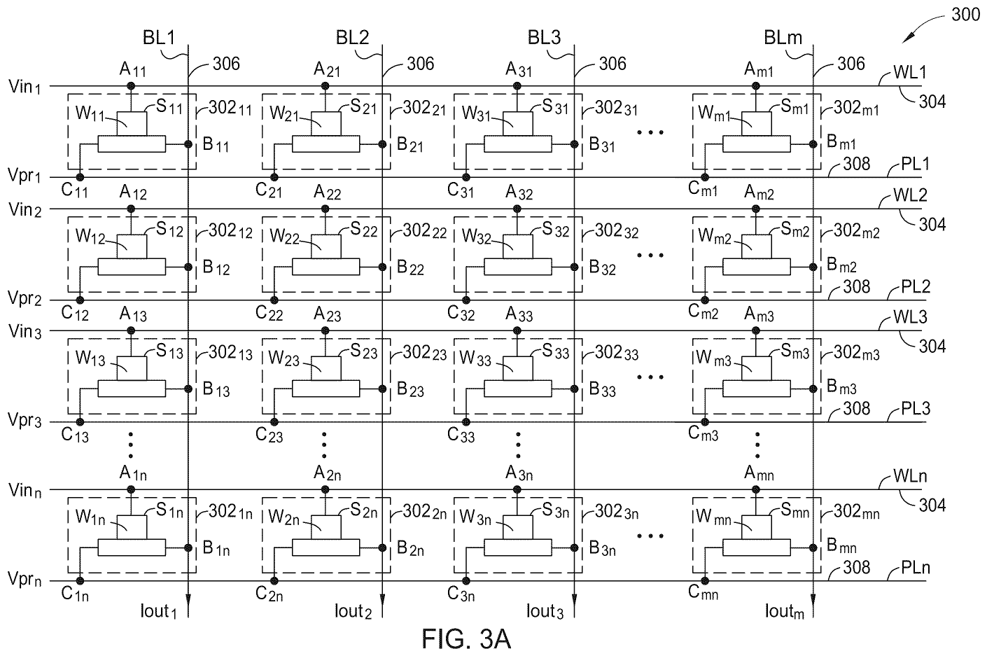

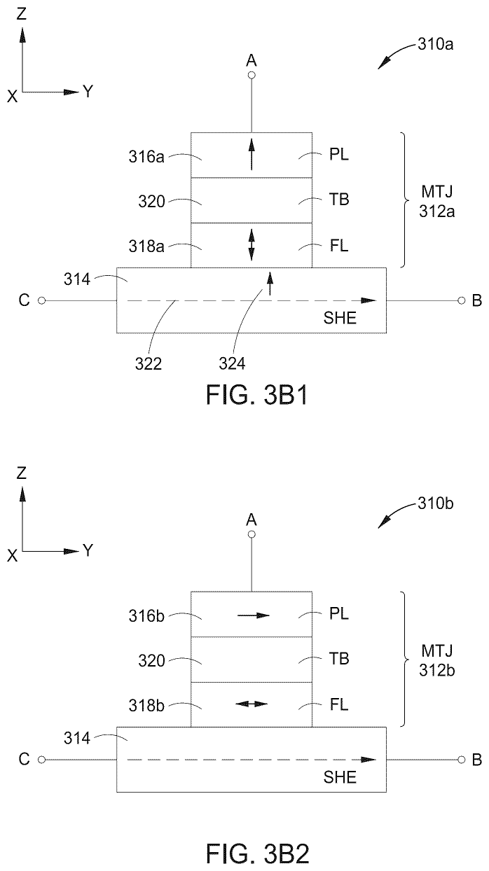

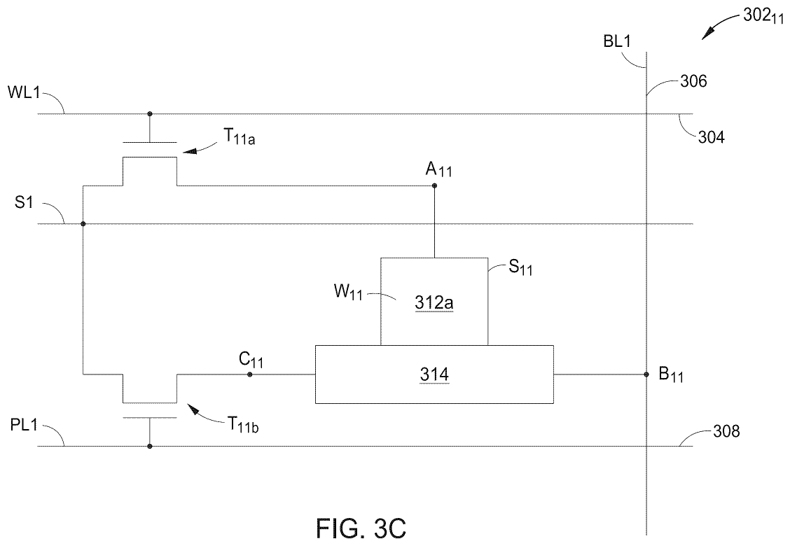

FIG. 3A is a simplified diagram of an embodiment of an apparatus 300 that may be used to perform the matrix-vector multiplication operation depicted in FIG. 2B. In an embodiment, apparatus 300 may be included in memory system 100 (FIG. 1A). In an embodiment, apparatus 300 may be included in memory chip 106 (FIG. 1A). In an embodiment, apparatus 300 may be used to perform multiply accumulate operations, such as matrix-vector multiplication in a neuromorphic computing system.

Apparatus 300 is a cross-point memory array that includes n rows and m columns of nodes 302₁₁, 302₁₂, . . . , 302ₘₙ. Apparatus 300 will also be referred to herein as cross-point memory array 300. In an embodiment, each of nodes 302₁₁, 302₁₂, . . . , 302ₘₙ includes a corresponding non-volatile memory cell S₁₁, S₁₂, . . . , Sₘₙ, respectively. In other embodiments, cross-point memory array 300 may include more than one non-volatile memory cell per node.

Each row of nodes 302₁₁, 302₁₂, . . . , 302ₘₙ is coupled to one of n first conductive lines 304, also referred to herein as word lines WL1, WL2, . . . , WLn. For example, the row of nodes 302₁₁, 302₂₁, 302₃₁, . . . , 302ₘ₁ is coupled to word line WL1, the row of nodes 302₁₃, 302₂₃, 302₃₃, . . . , 302ₘ₃ is coupled to word line WL3, and so on.

In an embodiment, each column of nodes 302₁₁, 302₁₂, . . . , 302ₘₙ is coupled to one of m second conductive lines 306, also referred to herein as bit lines BL1, BL2, . . . , BLm. For example, the column of nodes 302₁₁, 302₁₂, 302₁₃, . . . , 302₁ₙ is coupled to bit line BL1, the column of nodes 302₂₁, 302₂₂, 302₂₃, . . . , 302₂ₙ is coupled to bit line BL2, and so on.

In an embodiment, each row of nodes 302₁₁, 302₁₂, . . . , 302ₘₙ is coupled to one of n third conductive lines 308, also referred to as programming lines PL1, PL2, . . . , PLn. For example, the row of nodes 302₁₁, 302₂₁, 302₃₁, . . . , 302ₘ₁ is coupled to programming line PL1, the row of nodes 302₁ₙ, 302₂ₙ, 302₃ₙ, . . . , 302ₘₙ is coupled to programming line PLn, and so on. The programming lines PL1, PL2, . . . , PLn program a weight or state of each volatile memory cell S₁₁, S₁₂, . . . , Sₘₙ.

Each non-volatile memory cell S₁₁, S₁₂, . . . , Sₘₙ has a first terminal A₁₁, A₁₂, . . . , Aₘₙ, respectively, coupled to one of the n word lines WL1, WL2, . . . , WLn, a second terminal B₁₁, B₁₂, . . . , Bₘₙ, respectively, coupled to one of the m bit lines BL1, BL2, . . . , BLm, and a third terminal C₁₁, C₁₂, . . . , Cₘₙ, respectively, coupled to one of the n programming lines PL1, PL2, . . . , PLn. To simplify this discussion and to avoid overcrowding the diagram, access devices are not depicted in FIG. 3A.

For example, non-volatile memory cell S₁₁ has a first terminal A₁₁ coupled to word line WL1, a second terminal B₁₁ coupled to bit line BL1, and a third terminal C₁₁ coupled to programming line PL1. Likewise, non-volatile memory cell S₃₂ has a first terminal A₃₂ coupled to word line WL2, a second terminal B₃₂ coupled to bit line BL3, and a third terminal coupled C₃₂ to programming line PL2.

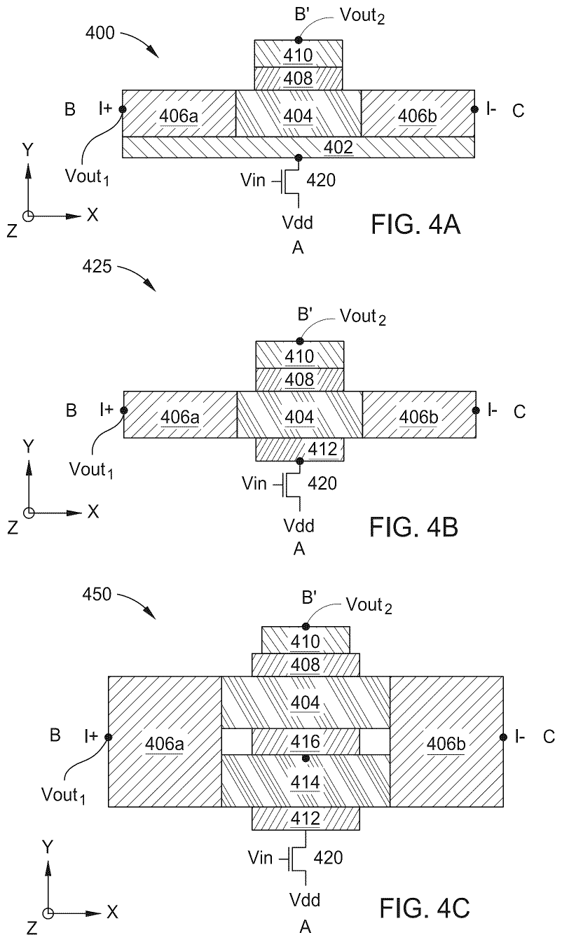

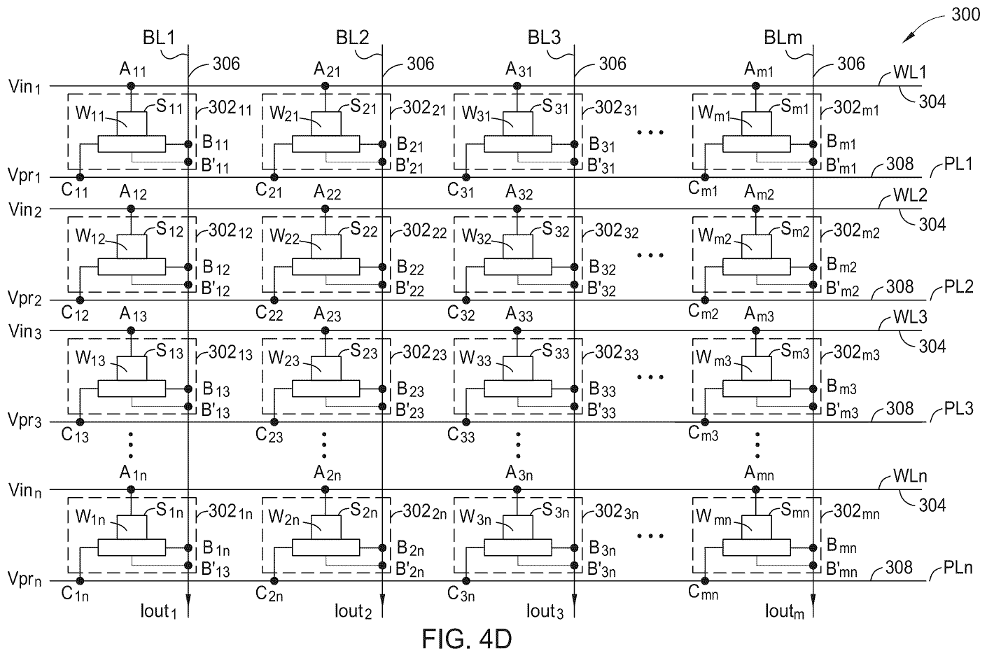

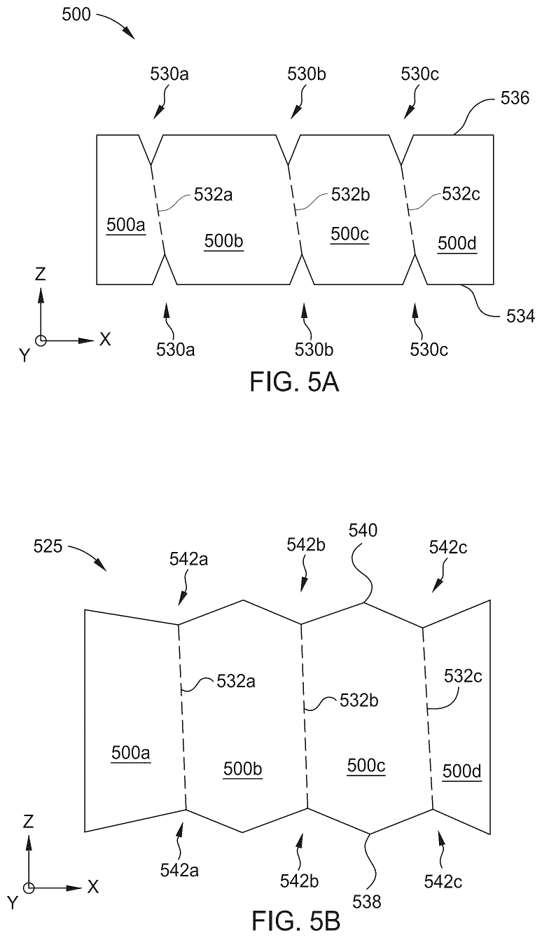

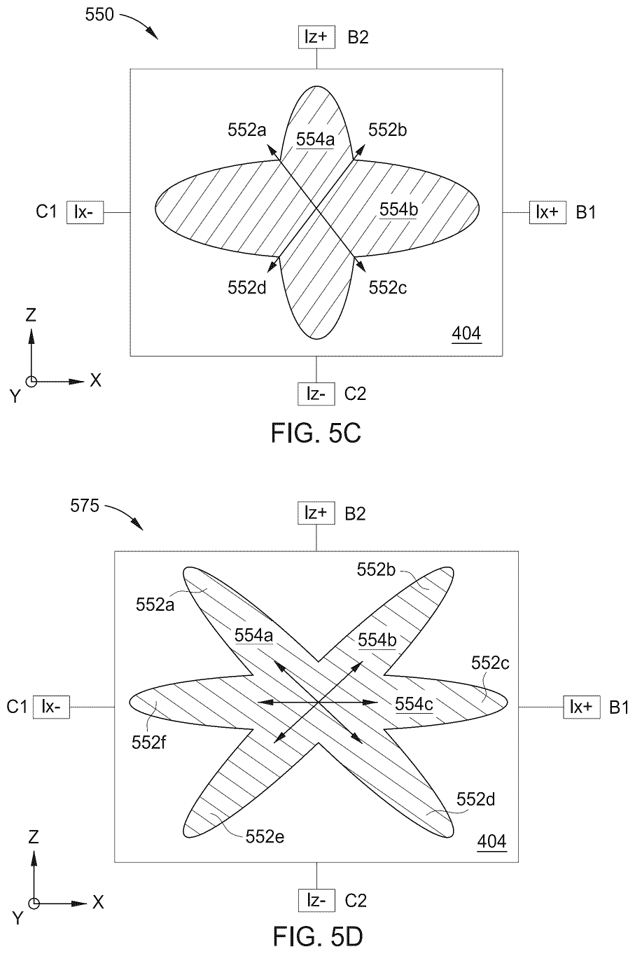

In the following figures, various non-volatile cell embodiments for implementing a multi-weight state SOT DNN approach are disclosed. Briefly, the free layers with domain walls or magnetic shape anisotropy in FIGS. 5A-5D provide the mechanisms for storing multi-weight states, and such free layers can be implemented in various memory cells shown in FIGS. 3B1-3C and FIGS. 4A-4C. FIGS. 3B1-3C disclose various magnetic tunnel junction (MTJ) based SOT cell embodiments for leveraging the magneto-resistive property of the MTJ for reading out (i.e., multiplying) the weight states. In contrast, FIGS. 4A-4C disclose embodiments for reading out (i.e., multiplying) the weight states via the inverse Spin Hall Effect or the direct Spin Hall Effect.

The MTJ approach will be described first using FIGS. 3B1-3B2, and FIG. 3C.

In an embodiment, each non-volatile memory cell S₁₁, S₁₂, . . . , Sₘₙ is a spin-orbit torque (SOT) magnetoresistive random-access memory (MRAM) non-volatile memory cell, such as the example SOT MRAM non-volatile memory cell 310a depicted in FIG. 3B1. SOT MRAM non-volatile memory cell 310a includes a first terminal A, a second terminal B, a third terminal C, a MTJ 312a, and a Spin Hall Effect (SHE) layer 314.

MTJ 312a includes a reference (or pinned) layer (PL) 316a, a free layer (FL) 318a, and a tunnel barrier (TB) 320 positioned between pinned layer 316a and free layer 318a. Tunnel barrier 320 is an insulating layer, such as magnesium oxide (MgO) or other insulating material. Pinned layer 316a is a ferromagnetic layer with a fixed direction of magnetization. Free layer 318a is a ferromagnetic layer and has a direction of magnetization that can be switched. Further description of the free layer 318a with domain walls or magnetic shape anisotropy are disclosed below in FIGS. 5A-5D.

Pinned layer 316a is usually a synthetic antiferromagnetic layer which includes several magnetic and non-magnetic layers, but for the purpose of this illustration is depicted as a single layer 316a with fixed direction of magnetization. Pinned layer 316a and free layer 318a each have a perpendicular direction of magnetization. Accordingly SOT MRAM non-volatile memory cell 310a is also referred to herein as “perpendicular stack SOT MRAM non-volatile memory cell 310a.”

When the direction of magnetization of free layer 318a is parallel to the direction of magnetization of pinned layer 316a, the resistance of perpendicular stack SOT MRAM non-volatile memory cell 310a is relatively low. When the direction of magnetization of free layer 318a is anti-parallel to the direction of magnetization in pinned layer 316a, the resistance of perpendicular stack SOT MRAM non-volatile memory cell 310a is relatively high.

Thus, generally the resistance of perpendicular stack SOT MRAM non-volatile memory cell 310a may therefore be used to store one bit of data. In an embodiment, SOT MRAM non-volatile memory cell 310a may be programmed to either a low resistance ON state or a high resistance OFF state. In an embodiment, the low resistance ON state may be used to represent a first weight value (e.g., “1”), and the high resistance OFF state may be used to represent a second weight value (e.g., “0”). The data (“0” or “1”) in SOT MRAM non-volatile memory cell 310a may be read by measuring the resistance of SOT MRAM non-volatile memory cell 310a. However, according to the domain wall or magnetic shape anisotropy based free layer approaches disclosed, discernable or discrete intermediate values between the binary “0” vs “1” may be stored and read-out, providing a mechanism for multi-weight state use in training and inference.

FIG. 3B2 is a cross-sectional view of another SOT MRAM non-volatile memory cell 310b that may be included in each non-volatile memory cell S₁₁, S₁₂, . . . , Sₘₙ (FIG. 3A). SOT MRAM non-volatile memory cell 310b includes first terminal A, second terminal B, third terminal C, a MTJ 312b having a pinned layer PL 316b and a free layer FL 318b that each have a direction of magnetization that is in an in-plane direction, and SHE layer 314. Accordingly SOT MRAM non-volatile memory cell 310b is also referred to herein as “in-plane stack SOT MRAM non-volatile memory cell 310b.”

When the direction of magnetization of free layer 318b is parallel to the direction of magnetization of pinned layer 316b, the resistance of in-plane stack SOT MRAM non-volatile memory cell 310b is relatively low. When the direction of magnetization of free layer 318b is anti-parallel to the direction of magnetization in pinned layer 316b, the resistance of in-plane stack SOT MRAM non-volatile memory cell 310b is relatively high.

Thus, generally the resistance of in-plane stack SOT MRAM non-volatile memory cell 310b may therefore be used to store one bit of data. In an embodiment, SOT MRAM non-volatile memory cell 310b may be programmed to either a low resistance ON state or a high resistance OFF state. In an embodiment, the low resistance ON state may be used to represent a first weight value (e.g., “1”), and the high resistance OFF state may be used to represent a second weight value (e.g., “0”). The data (“0” or “1”) in SOT MRAM non-volatile memory cell 310b may be read by measuring the resistance of SOT MRAM non-volatile memory cell 310b. However, according to the domain wall or magnetic shape anisotropy based free layer approaches disclosed, additional values beyond the binary “0” vs “1” may be stored and read-out, providing a mechanism for multi-weight state use in training and inference.

Referring again to FIG. 3B1, in an embodiment, SHE layer 314 comprises a heavy metal with strong spin orbit coupling and large effective Spin Hall Angle. Examples of heavy metal materials include platinum, tungsten, tantalum, platinum gold (PtAu), bismuth bopper (BiCu). In other embodiments, SHE layer 314 comprises a topological insulator, such as bismuth antimony (BiSb), bismuth selenide (Bi₂Se₃), bismuth telluride (Bi₂Te₃) or antimony telluride (Sb₂Te₃). In particular embodiments, SHE layer 314 comprises BiSb with (012) orientation, which is a narrow gap topological insulator with both giant Spin Hall Effect and high electrical conductivity. In other embodiments, SHE layer 314 comprises a topological semi-metal (TSM) material, such as BiSb, YPtBi, FeSi, or CoSi.

The spin of an electron is an intrinsic angular momentum. In a solid, the spins of many electrons can act together to affect the magnetic and electronic properties of a material, for example endowing it with a permanent magnetic moment as in a ferromagnet. In many materials, electron spins are equally present in both up and down directions. However, various techniques can be used to generate a spin-polarized population of electrons, resulting in an excess of spin up or spin down electrons, to change the properties of a material. This spin-polarized population of electrons moving in a common direction through a common material is referred to as a spin current.

The Spin Hall Effect is a transport phenomenon that may be used to generate a spin current in a sample carrying an electric current. The spin current is in a direction perpendicular to the plane defined by the electrical current direction and the spin polarization direction. The spin polarization direction of such a SHE-generated spin current is in the in-plane direction orthogonal to the electrical current flow.

For example, an electrical current 322 through SHE layer 314 (from third terminal C to second terminal B) results in a spin current 324 being injected up into free layer 318a, and having a direction of polarization into the page. Spin current 324 injected into free layer 318a exerts a spin torque (or “kick”) on free layer 318a, which causes the direction of magnetization of free layer 318a to oscillate in the y-z plane or to be changed entirely. This can be leveraged for programming the weight state in the free layer during the training phase.

In an embodiment, during a “programming phase,” each SOT MRAM non-volatile memory cell S₁₁, S₁₂, . . . , Sₘₙ is programmed to store a corresponding weight of an n×m array of weights w₁₁, w₁₂, w₁₃, . . . , wₙₘ, respectively. For example, any suitable programming may be used to store weights w₁₁, w₁₂, w₁₃, . . . , wₙₘ in SOT MRAM non-volatile memory cell S₁₁, S₁₂, . . . , Sₘₙ, respectively. As described above, in an embodiment, each of weights w₁₁, w₁₂, w₁₃, . . . , wₙₘ can represent one of several states in a multi-state weight scheme.

After SOT MRAM non-volatile memory cells S₁₁, S₁₂, . . . , Sₘₙ have been programmed with weights w₁₁, w₁₂, w₁₃, . . . , wₙₘ, respectively, e.g., as part of training a neural network, cross-point memory array 300 may be used during an “inferencing phase” to perform the matrix-vector multiplication operation depicted in FIG. 2B. In particular, multiply voltages Vin₁, Vin₂, . . . , Vinₙ are applied to word lines WL1, WL2, . . . , WLn, respectively. In an embodiment, read/write/multiply circuit 124 is configured to apply multiply voltages Vin₁, Vin₂, . . . ,Vinₙ to word lines WL1, WL2, . . . , WLn, respectively. The magnitudes of voltages Vin₁, Vin₂, . . . , Vinₙ correspond to the associated values of input neurons x₁, x₂, . . . , xₙ, respectively, and hence multiply voltages Vin₁, Vin₂, . . . , Vinₙ constitute an n-element input vector (multiply vector).

In an embodiment with use of MTJ based cell of FIGS. 3B1-B2, during the inferencing phase, third conductive lines 308 (programming lines PL1, PL2, . . . , PLn) are not used, and may be floated. In addition, for simplicity it will be assumed that bit line select voltages of 0 volts are applied to each of bit lines BL1, BL2, . . . , BLm to select those bit lines. In an embodiment, read/write/multiply circuit 124 is configured to apply bit line select voltages of 0 volts to bit lines BL1, BL2, . . . , BLm.

During the inferencing phase, each SOT MRAM non-volatile memory cell S₁₁, S₁₂, . . . , Sₘₙ conducts a memory cell current that corresponds to the result of multiplying one of the elements of the n-element input vector (multiply vector) by the corresponding weight stored in the non-volatile memory cell. For example, SOT MRAM non-volatile memory cell S₁₁ conducts a memory cell current that corresponds to the product Vin₁×w₁₁, SOT MRAM non-volatile memory cell S₁₂ conducts a memory cell current that corresponds to the product Vin₂×w₁₂, SOT MRAM non-volatile memory cell S₂₃ conducts a memory cell current that corresponds to the product Vin₃×w₂₃, and so on.

During the inferencing phase, the memory cell currents in SOT MRAM non-volatile memory cells S₁₁, S₁₂, . . . , Sₘₙ flow to the bit line BL1, BL2, . . . , BLm connected to the memory cell. Bit lines BL1, BL2, . . . , BLm conduct bit line currents Iout₁, Iout₂, . . . , Ioutₘ, respectively. Each bit line current is the summation of the memory cell currents of the memory cells connected to that bit line. Thus, each bit line current Iout₁, Iout₂, . . . , Ioutₘ may be viewed as representing a sum of products of the multiply vector with corresponding weights in a column of the n×m array of weights:

$${Iout}_{1} = {Vin}_{1} \times {w}_{11} + {Vin}_{2} \times {w}_{12} + … {Vin}_{n} \times {w}_{1 n} \qquad ( 8 )$$

$${Iout}_{2} = {Vin}_{1} \times {w}_{21} + {Vin}_{2} \times {w}_{22} + … {Vin}_{n} \times {w}_{2 n} \qquad ( 9 )$$

$$…$$

$${Iout}_{m} = {Vin}_{1} \times {w}_{m 1} + {Vin}_{2} \times {w}_{m 2} + … {Vin}_{n} \times {w}_{mn} \qquad ( 10 )$$

The magnitudes of bit line currents Iout₁, Iout₂, . . . , Ioutₘ constitute elements of an m-element output vector, and correspond to the associated values of output neurons y₁, y₂, . . . , yₘ, respectively, and constitute the result of the matrix-vector multiplication operation depicted in FIG. 2B.

The magnitude of each individual bit line current Iₖ represents a vector-vector multiplication result. That is, the magnitude of bit line current Iₖ represents the result of multiplying the input vector Vin₁, Vin₂, . . . , Vinₙ by the k-th column vector of the n×m array of weights w₁₁, w₁₂, w₁₃, . . . , wₙₘ.

Collectively, bit line currents Iout₁, Iout₂, . . . , Ioutₘ represent a result of matrix-vector multiplication. In an embodiment, bit line currents Iout₁, Iout₂, . . . , Ioutₘ represent output neurons y₁, y₂, y₃, . . . , yₘ, respectively, of artificial neural network 200 of FIG. 2A. Because one node SOT MRAM non-volatile memory cell S₁₁, S₁₂, . . . , Sₘₙ in each column is connected to the same first conductive line 308, the matrix-vector multiplication is very efficient. Essentially, m vector-vector multiplications are performed in parallel.

In an embodiment, a sense amplifier is used to compare the magnitude of each bit line current Iout₁, Iout₂, . . . , Ioutₘ to a reference current. The sense amplifier may output a signal (e.g., one bit of information) that indicates whether the magnitude of the bit line current is less than or greater than the reference current. In an embodiment, the magnitude of the bit line current may be input to an activation function in an artificial neural network. The activation function may take various forms (e.g., Rectified Linear Unit (ReLu)) and may involve operations on the bit line current other than comparing to a reference current. In some applications, the activation function outputs a “fire” or “don't fire” signal based on the magnitude of the summed signal.

As described above, to avoid overcrowding the diagram, access devices are not depicted in FIG. 3A. FIG. 3C is a diagram of node 302₁₁ that includes a first access device T₁₁ₐ, a second access device T_{11b}. and a signal line S1. SOT MRAM non-volatile memory cell S₁₁ includes first terminal A₁₁ coupled via first access device T₁₁ₐ to first conductive line 304 (word line WL1), second terminal B11 coupled to second conductive line 306 (bit line BL1), and third terminal C₁₁ coupled via second access device T_{11b} to third conductive line 308 (programming line PL1).

In an embodiment, first access device T₁₁ₐ and second access device T_{11b} are each MOS transistors, although other types of access device may be used. First access device T₁₁ₐ has a first drain/source terminal coupled to signal line S1, a second drain/source terminal coupled to first terminal A₁₁ of SOT MRAM non-volatile memory cell S₁₁, and a control (gate) terminal coupled to first conductive line 304 (word line WL1). Second access device T_{11b} has a first drain/source terminal coupled to signal line S1, a second drain/source terminal coupled to third terminal C₁₁ of SOT MRAM non-volatile memory cell S₁₁, and a control (gate) terminal coupled to third conductive line 308 (programming line PL1). It is noted that FIG. 3C shows one example embodiment, and that other access device configurations are possible.

During inferencing, first conductive line 304 (word line WL1) is HIGH, third conductive line 308 (programming line PL1) is LOW, first access device T₁₁ₐ is ON, second access device T_{11b} is OFF, and multiply voltage Vin₁ is applied to signal line S1 while a bit line select voltage (e.g., 0V) is applied to second conductive line 306 (bit line BL1). As a result, multiply voltage Vin₁ is applied across first terminal A₁₁ and second terminal B11 of SOT MRAM non-volatile memory cell S₁₁, and SOT MRAM non-volatile memory cell S₁₁, conducts a memory cell current that corresponds to the product Vin₁×w₁₁.

Similar programming and inferencing techniques to those described above in connection with SOT MRAM non-volatile memory cell S₁₁ of FIG. 3C may be used for programming and inferencing SOT MRAM non-volatile memory cells S₁₁, S₁₂, . . . , Sₘₙ of FIG. 3A. In an embodiment, each row of SOT MRAM non-volatile memory cells S₁₁, S₁₂, . . . , Sₘₙ is coupled to the same signal line S₁ so that all SOT MRAM non-volatile memory cells in the row receive the same multiply voltage Vin₁, Vin₂, . . . , Vinₙ.

While FIGS. 3B1-3C above disclose various MTJ based SOT cell embodiments for leveraging the magneto-resistive property of the MTJ for reading out (i.e., multiplying) the weight states, FIGS. 4A-4C disclose embodiments for reading out (i.e., multiplying) the weight states via the inverse Spin Hall Effect or the direct Spin Hall Effect. Where applicable, the general description above related to programming weight states during training and reading weight states during inference still apply to the embodiments of FIGS. 4A-4C, as well as FIGS. 5A-5D.

FIGS. 4A-4C illustrate cross-sectional views of SOT cells 400, 425, 450, respectively, that may be included in each non-volatile memory cell S₁₁, S₁₂, . . . , Sₘₙ of FIG. 3A or FIG. 4D, each implementing the DNN of FIG. 2A, according to various embodiments. A neural network, such as the DNN 200 of FIG. 2A, may utilize a plurality of the SOT cells 400, 425, 450 for inference. FIG. 4D depicts another embodiment of a cross-point memory array that may be used to perform the matrix-vector multiplication operation depicted in FIG. 2B.

The SOT cell 400 of FIG. 4A comprises a buffer layer 402, an SOT layer 404 disposed on the buffer layer 402, a ferromagnetic (FM) layer 408 disposed on the SOT layer 404, and a cap layer 410 disposed on the FM layer 408. Electrodes 406a, 406b are disposed adjacent to the SOT layer 402 on the buffer layer 402. A transistor 420 is coupled to the buffer layer 402 side of the stack via the buffer layer (or another layer or electrode option not shown), and is aligned with the SOT and FM layers 404, 408. In some embodiment, the buffer layer 402 may be a seed layer. The FM layer 408 has a shorter length in the x-direction than the SOT layer 404 such that the FM layer 408 is spaced from the electrodes 406a, 406b. The FM layer 408 may comprise CoFe, NiFe, CoFeB, CoB, CoHf, CoFePt, CoPt, CoPtCrB, or a combination thereof. A current input line (Vin) and a current supply line (Vdd) are coupled to the transistor 420. Terminals A, B, B′, and C correspond to the like-labeled terminals in FIG. 4D, and if B′ is not implemented, A, B, and C correspond to the like-labeled terminals in FIG. 3A. FIG. 4D is the same as FIG. 3A, except for the additional option of a terminal B′ in each memory cell. It is noted in this and other embodiments shown in FIGS. 4A-4C, additional layers such as interlayers between the SOT and FM layers may be present.

During operation, to set a weight, a current is applied to the I+/I− current line (across terminals B and C) such that current flows through the first electrode 406a, to the SOT layer 404, to the second electrode 406b in the x-direction. Due to the spin Hall effect, the SOT cell 400 magnetic state will be set by an induced spin current flowing in the y-direction. By doing so, the weight is set (i.e., a preset resistance) in the FM layer 408. The exact weight/state is decided during the training process. Once the weight is preset, the preset current can be removed. Due to the nonvolatile nature of SOT cells, such weight can still be maintained without power (i.e., current).

To read the state of the FM layer 408 during inference, in the inverse spin Hall effect case, the Vin current line is supplied with current through the supply current (Vdd) and the transistor 420 (via terminal A). A read output (Vout₁) current is read through the I+/I− current line to read the state of the FM layer 408 based on the inverse spin Hall effect. The Vout₁ at terminal B for the respective cells are, as shown in FIG. 3A, summed along the bitlines. Thus, the state of the FM layer 408 is both set and read via the I+/I− current line. The terms “weight” and “state” may be used interchangeably throughout.

Alternatively, the direct spin Hall effect may be used, in which case, the read output is through Vout₂. In this case, an input voltage would be provided at terminal C (instead of A), which in the context of FIG. 4D, would involve driving an input voltage in PLn, running in the plane of the SOT layer. In that case, PLn is both used as a programming line (as Vprₙ) and as an input line (as Vinₙ). Output is then provided to terminal B′ and summed along the bitlines as described above. Further details of an example mechanism for reading out an FM layer using the direct spin Hall effect is provided in co-pending application Ser. No. 18/666,543, filed May 16, 2024, titled “Sensor based on Direct Spin Hall Effect,” the disclosure of which is hereby incorporated by reference. It is further noted that, depending on the reading effect used, the cells can be configured with the corresponding terminals (B or B′) so they remain 3-terminal devices.

The SOT cell 425 of FIG. 4B is similar to the SOT cell 400 of FIG. 4A; however, the SOT cell 425 further comprises a second FM layer 412. The SOT layer 404 is sandwiched between the first FM layer 408 and the second FM layer 412. While a buffer or seed layer not shown, the second FM layer 412 may be disposed on such a buffer or seed layer. The transistor 420 may be coupled to the buffer/seed layer or the second FM layer 412 side of the stack via either layer, or another layer or electrode option not shown. The first and second FM layers 408, 412 have a shorter length in the x-direction than the SOT layer 404 such that the first and second FM layers 408, 412 are spaced from the electrodes 406a, 406b. Utilizing two or more FM layers improves the precision of the weight of the SOT cells, enabling multi-state weight beyond binary weight. The SOT cell 425 may further comprise a current output line (Vout₂) coupled to the cap layer 410. Terminals A, B, B′ and C correspond to the like-labeled terminals in FIG. 4D, and if B′ is not implemented, A, B, and C correspond to the like-labeled terminals in FIG. 3A.

The first and second FM layers 408, 412 may comprise different materials. For example, the first FM layer 408 may comprise a high coercivity (Hk) material and the second FM layer 412 may comprise a low coercivity material, or vice versa. Examples of low Hk materials include CoFe, NiFe, CoFeB, CoB, CoHf, and combinations thereof. Examples of high Hk materials include Pt, such as CoFePt, CoPt, CoPtCrB. By adjusting the concentration of Pt, the material properties of the FM layers 408, 412 can be effectively tuned, resulting in a wide range of Hk values. The SOT cell 425 has four possible states: 1) the first FM layer 408 being 0 and the second FM layer 412 being 1; 2) the first FM layer 408 being 1 and the second FM layer 412 being 2; 3) the first and second FM layers 408, 412 both being 0; or 4) the first and second FM layers 408, 412 both being 1. By doing so, multi-state weight can be achieved instead of binary.

The first and second FM layer 408, 412 may have different states, and can be individually programmed via the I+/I− current line. The FM layer 408 or 312 comprising the high coercivity material requires a greater amount of current to set the state. In one embodiment, the FM layer 408 or 412 comprising the high coercivity material is programmed first, and the state of the FM layer 408 or 412 comprising the low coercivity material is programmed last with a smaller current than that needed for the high coercivity material, such that the state of higher coercivity layer is not disturbed.

The state of the FM layers 408, 412 may be read out through either at Vout₁ (terminal B), by utilizing the inverse spin Hall effect, or at Vout₂ (terminal B′), by utilizing the direct spin Hall effect. The direct spin Hall effect may be used, in which case, an input voltage would be provided at terminal C (instead of A), which in the context of FIG. 4D, would involve driving an input voltage in PLn, running in the plane of the SOT layer. In that case, PLn is both used as a programming line (as Vprₙ) and as an input line (as Vinₙ). Output is then provided to terminal B′ and summed along the bitlines as described above. It is further noted that, depending on the reading effect used, the cells can be configured with the corresponding terminals (B or B′) so they remain 3-terminal devices.

With the two FM layers present, the output signal would be a composite, representative of the magnetization states of the two FM layers. For example, if both layers are at a “high” state direction, the composite output signal would be “high.” Similarly, the output signal would be “low” if both FM layers are at a “low” state magnetization direction. A third state between “high” and “low” would represent the scenario when one FM layer has an opposite magnetization relative to that of the other FM layer. So at least three states can be encoded with the use of two FM layers. The same logic would apply to any arrangement with additional FM layer(s), including the example embodiment of FIG. 4C.

The SOT cell 450 of FIG. 4C is similar to the SOT cell 400 of FIG. 4A; however, the SOT cell 450 further comprises a third FM layer 416 and a second SOT layer 414. Like for FIG. 4B, terminals A, B, B′ and C correspond to the like-labeled terminals in FIG. 4D. The first FM layer 408 is disposed on the first SOT layer 404, the third FM layer 416 is disposed below the first SOT layer 404, on the second SOT layer 414, and the second FM layer 412 is disposed below the second SOT layer 414. In other words, the first SOT layer 404 is sandwiched between the first and third FM layers 408, 416, and the second SOT layer 414 is sandwiched between the second and third FM layers 412, 416. While the buffer or seed layer is not shown, the second FM layer 412 may be disposed on such a buffer or seed layer. The transistor 420 may be coupled to the buffer layer or the second FM layer 412 side of the stack via the second FM layer, the buffer layer or another layer or electrode option not shown. The first, second, and third FM layers 408, 412, 416 have a shorter length in the x-direction than the first and second SOT layers 404, 414 such that the first, second, and third FM layers 408, 412, 416 are spaced from the electrodes 406a, 406b.

The first, second, and third FM layers 408, 412, 416 comprise different materials or materials having different coercivities. The SOT cell 450 has eight possible states, where each binary digit of the following numbers represents a state of each of the FM layers 408, 412, 416, respectively: 1) 000; 2) 100; 3) 110; 4) 111; 5) 010; 6) 001; 7) 101; and 8) 011. As noted above, the read output signal is a composite signal representing the magnetization of the FM layers, and would provide discrete levels to distinguish among these eight states. The state of the FM layers 408, 412 are read out through either at Vout1 (terminal B), by utilizing the inverse spin Hall effect, or at Vout₂ (terminal B′), by utilizing the direct spin Hall effect, as described above. Such multi-state FM layers enable multi-state weight compared to binary weight (BNN).

The SOT layers 404 and 414 may comprise a topological insulator (TI) material or a topological semi-metal (TSM) material, such as BiSb, YPtBi, FeSi, or CoSi. Thanks to their giant spin Hall angle, TI and TSM materials having spin-momentum locking surface states are promising for a spin current source. Hence, TI and TSM materials have the potential for ultra-low-power consumption when utilized in SOT cells. The SOT layers 404 and 414 each have a thickness in the y-direction of about 10 nm to about 20 nm, and a length in the x-direction of about 10 nm to about 1 μm.

The electrodes 406a, 406b may comprise Cu, Al, AlN, or regular metals, have a thickness in the y-direction of about 200 nm to about 400 nm, and a length in the x-direction of about 10 nm to about 1 μm. The FM layers 408, 412, 416 may comprise CoFe, NiFe, CoFeB, CoB, CoHf, CoFePt, CoPt, CoPtCrB, or a combination thereof, have a thickness in the y-direction of about 5 nm to about 20 nm, and a length in the x-direction of about 10 nm to about 1 μm. The cap layer may comprise Spinel, HfN, NiFeGe, MgO, Ru, Ta, W, or a combination thereof, have a thickness in the y-direction of about 4 nm to about 10 nm, and a length in the x-direction of about 10 nm to about 1 μm.

FIGS. 5A-5D illustrate top views of FM layers 500, 525, 550, 575, respectively, that may be utilized in the SOT cells 310a and 310b of FIGS. 3B1-3B2 and the SOT cells 400, 425, 450 of FIGS. 4A-4C, according to various embodiments. The FM layers 500, 525, 550, 575 may each individually be the FM layers 318a and 318b of FIGS. 3B1-3B2, and FM layers 408, 412, and/or 416 of FIGS. 4A-4C. Thus, FIGS. 5A-5D may be used in combination with FIGS. 3B1-3B2 and 4A-4C.

The FM layer 500 of FIG. 5A comprises a plurality of domain walls 532a, 532b, 532c intentionally designed and formed by cutting notches 530a, 530b, 530c on a first surface 534 and a second surface 536 opposite the first surface 534. While three domain walls 532a-532c are shown, the FM layer 500 may have a greater or lesser amount of domain walls 532a-532c. The notches 530a-530c have a depth in the z-direction of up to about 20% of the height of the FM layer 500 in the z-direction. The domain walls 532a-532c enable the portions or domains 500a, 500b, 500c, 500d of the FM layer 500 between the domain walls 532a-532c to each have their own individual magnetization orientation/state. Three domain walls 532a-532c enable the FM layer 500 to have five individual states, where each binary digit of the following numbers represents a state of each of the domains 500a-500d: 1) 1111; 2) 1110; 3) 1100; 4) 1000; or 5) 0000. In essence, rather than providing a binary output signal of a high vs. low state to encode two weight states, the read out signal in this embodiment would have distinguishable levels for at least these five states, as the number of magnetization direction in one direction (“1”) or another (“0”) in the domains would affect the composite signal output. This similar principle applies to the other embodiments shown in FIGS. 5B-5D. Utilizing an FM layer having multiple domains enables multi-state weight as compared to binary weight (BNN) and improves the accuracy of a neural network being implemented in these SOT cells.

Varying amounts of current applied in the x-direction are used to change the state of each of domains 500a-500d. For example, a first current with a large amount of magnitude may be applied to the FM layer 500 to reset the state of each of domains 500a-500d to 0. A second small amount of current applied in the opposite direction may then be applied to the FM layer 500 to change the first domain 500a to 1 and drive the domain wall movement. The time duration of the second current is set such that the state of one or more domains 500a-500d are changed. Thus, the longer the dwell time of the second current that is applied, the more the domains 500a-500d are changed. In an SOT cell having multiple FM layers, such as the SOT cells 425 and 450 of FIGS. 4B and 4C, each FM layer may be the FM layer 500 having multiple states.

The FM layer 525 of FIG. 5B is similar to the FM layer 500 of FIG. 5A; however, the first surface 538 and the second surface 540 of the FM layer 525 are zigzagged in shape. The FM layer 525 does not comprise the notches 530a-530c. Rather, the first and second surfaces 538, 540 are symmetrical such that the low points 542a, 542b, 542c of the zigzags are aligned in the z-direction. The low points of the zigzags 542a-542c form the domain walls 532a-532c, enabling the domains 500a, 500b, 500c, 500d of the FM layer 500 between the domain walls 532a-532c to each have their own individual state, as discussed above. While three domain walls 532a-532c are shown, the FM layer 500 may have a greater or lesser amount of domain walls 532a-532c. In an SOT cell having multiple FM layers, such as the SOT cells 425 and 450 of FIGS. 4B and 4C, each FM layer may be the FM layer 525 having multiple states.

The FM layer 550 of FIG. 5C is similar to the FM layers 500 and 525 of FIGS. 5A and 5B; however, rather than comprising notches or zigzagged surfaces, the FM layer 550 has a multi-elliptical shape that utilizes magnetic shape anisotropy to set the magnetic orientations or change the states at the locations or corners 552a-552d. The FM layer 550 is made up of two elongated elliptical shaped portions 554a, 554b that are disposed perpendicular to one another to form a cross or x-like shape. The two easy axes along the directions 552a/552c and the directions 552b/552d are created at the corners of the multi-elliptical shaped FM layer 550.

The varying directions and magnitude of current (I) applied in the xz-plane inside the SOT layer 404, which is disposed below the FM layer 550, is used to control/set the magnetic orientation of the FM layer 550 along one of the axes for the corners 552a-552d. The current is applied directionally using two current sources: Iz+/Iz− and Ix+/Ix−. The associated terminals are marked with the corresponding terminal notations in FIG. 3A, except that each terminal B and C for each cell is split, so that the programming currents are directed in multiple paths in the SOT layer plane. As shown, there are two current paths: B1-C1 and B2-C2. This facilitates an equal amount of current applied in the +x and +z-direction using the Ix and Iz current sources may then be applied to set the magnetic orientation of the FM layer 550 along the corner 552a, or an equal amount of current applied in the −x and −z-direction using the Ix and Iz current sources may be applied to set the magnetic orientation of the FM layer 550 along the corner 552c. Thus, the direction and magnitude of the current applied is used to control/set the states of the corners 552a-552d. To read the states, depending on the SOT cells used as described above, the magneto-resistive, inverse spin Hall, or direct spin Hall effect may be utilized. Much like the domain wall embodiments above, the read out signal is a composite, representative of the multiple magnetizations within the FM layer, so that more than two signal levels can be discerned, encoding more than two weight states. In an SOT cell having multiple FM layers, such as the SOT cells 425 and 450 of FIGS. 4B and 4C, each FM layer may be the FM layer 550 having multiple states. While the FM layer 550 is shown being disposed on the SOT layer 404, the FM layer 550 may be disposed on any SOT layer.

The FM layer 575 of FIG. 5D is similar to the FM layer 550 of FIG. 5C; however, the FM layer 575 comprises three elliptical shaped portions 554a, 554b, 554c to create six states in the elliptical arms 552a-552f. The three elliptical shaped portions 554a-554c are disposed at an angle with respect to one another. As a result, the FM layer 575 can have six discrete states along one of the six elliptical arms 552a-552f. The associated terminals are marked with the corresponding terminal notations in FIG. 3A, except that each terminal B and C for each cell is split, so that the programming currents are directed in multiple paths in the SOT layer plane. The setting of the magnetization state using current applied in different axes and magnitudes is done as described above. For example, an unequal amount of current applied in the +x and +z-direction (e.g., more current applied in the +x-direction than in the +z-direction) using the Iz+ and Ix+ current sources may be used to change the state to be along the elliptical arms 552a. To read the states, depending on the SOT cells used as described above, the magneto-resistive, inverse spin Hall, or direct spin Hall effect may be utilized. Much like the domain wall embodiments above, the read out signal is a composite, representative of the multiple magnetizations within the FM layer, so that more than two signal levels can be discerned, encoding more than two weight states. In an SOT cell having multiple FM layers, such as the SOT cells 425 and 450 of FIGS. 4B and 4C, each FM layer may be the FM layer 575 having multiple states. While the FM layer 575 is shown being disposed on the SOT layer 404, the FM layer 575 may be disposed on any SOT layer.

Therefore, utilizing a plurality of SOT cells in an artificial neural network or DNN enables the neural network to have ultra-low-power consumption. Furthermore, by utilizing two or more FM layers, FM layers having multiple domains, or FM layers having a multi-elliptical shape, within each SOT cell can encode weight states beyond binary states, thus improving the accuracy of the neural network.

In one embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT) cells, each SOT cell comprising: a SOT layer, a ferromagnetic (FM) layer disposed on the SOT layer, the FM layer being configured with a plurality of domain walls, electrodes disposed adjacent to the SOT layer, the electrodes being spaced from the FM layer, and a first current line configured to apply current through a first electrode of the electrodes, to the SOT layer, to a second electrode of the electrodes, and a controller configured to store at least one corresponding weight of an n×m array of weights of a neural network in each of the SOT cell.

The SOT layer comprises BiSb, YPtBi, FeSi, or CoSi. The FM layer has a plurality of cutting notches, so that at least one cutting notch separates a domain from another adjacent domain. The FM layer comprises a first surface and a second surface, the first and second surfaces being zigzagged. The DNN device further comprises a tunnel barrier layer on the FM layer, a second FM layer on the tunnel barrier layer, wherein the FM layer, the tunnel barrier layer and the second FM layer form a magnetic tunnel junction and a magnetic state of the FM layer is read via a magneto-resistive effect. The DNN device further comprises a transistor coupled to the SOT cell for applying an input voltage flowing perpendicular to a plane of the SOT layer and FM layer, wherein a magnetic state of the FM layer is read via the inverse spin Hall effect. A magnetic state of the FM layer is read via the direct spin Hall effect, where an input current is driven between the first and second electrodes in a plane of the SOT layer. The controller is further configured to use a magnetic state of each of a plurality of domains of the FM layer to encode a multi-state weight value having three or more states.

In another embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT) cells, each SOT cell comprising: a first ferromagnetic (FM) layer, a SOT layer disposed on the first FM layer, a second FM layer disposed on the SOT layer, and electrodes disposed adjacent to the SOT layer, the electrodes being spaced from the first and second FM layers, and a controller configured to store at least one corresponding weight of an n×m array of weights of a neural network in each of the SOT cell.

At least one of the first FM layer or the second FM layer has a multi-elliptical shape creating two or more states, wherein each state of the two or more states is configured to have a weight value. At least one of the first FM layer or the second FM layer FM layer has a plurality of cutting notches, so that at least one cutting notch separates a domain from another adjacent domain. At least one of the first FM layer or the second FM layer FM layer comprises a first surface and a second surface, the first and second surfaces being zigzagged. The first FM layer and the second FM layer comprise different materials. The first FM layer comprises CoFe, NiFe, CoFeB, CoB, CoHf, or a combination thereof, and wherein the second FM layer comprises CoFePt, CoPt, CoPtCrB, or a combination thereof. The first FM layer has a higher coercivity than the second FM layer. The controller is further configured to use a magnetic state of the first FM layer and a magnetic state of the second FM layer to encode a multi-state weight value having three or more states.

In yet another embodiment, a deep neural network (DNN) device, the DNN device comprising an array comprising n rows and m columns of nodes, each row of nodes coupled to one of n first conductive lines, each column of nodes coupled to one of m second conductive lines, each node of the n rows and m columns of nodes comprising a plurality of spin orbit torque (SOT) cells, each SOT cell comprising: a first SOT layer, a first ferromagnetic (FM) layer disposed on the first SOT layer, the first FM layer having a multi-elliptical shape creating two or more magnetic states at two or more corners or two or more arms formed by the multi-elliptical shape, and a current input configured to apply current through: a first current path across the first SOT layer and a second current path across the first SOT layer, and a controller configured to store at least one corresponding weight of an n×m array of weights of a neural network in each of the SOT cell.

The DNN device further comprises: a second FM layer, a second SOT layer, and a third FM layer. The first, second, and third FM layer each comprises a different material. The first, second, and third FM layer each comprises a material selected from the group consisting of: CoFe, NiFe, CoFeB, CoB, CoHf, CoFePt, CoPt, CoPtCrB, or a combination thereof. One or more of the second FM layer and the third FM layer has a multi-elliptical shape creating two or more magnetic states at two or more corners or two or more arms formed by the multi-elliptical shape. The first and second current paths are perpendicular to each other.

While the foregoing is directed to embodiments of the present disclosure, other and further embodiments of the disclosure may be devised without departing from the basic scope thereof, and the scope thereof is determined by the claims that follow.

What is claimed is:

1. A deep neural network (DNN) device, the DNN device comprising:
an array comprising n rows and m columns of nodes, each row of nodes coupled to one of n first conductive lines, each column of nodes coupled to one of m second conductive lines, each node of the n rows and m columns of nodes comprising a plurality of spin-orbit torque (SOT) cells, each SOT cell comprising:
a SOT layer;
a ferromagnetic (FM) layer disposed on the SOT layer, the FM layer being configured with a plurality of domain walls;
electrodes disposed adjacent to the SOT layer, the electrodes being spaced from the FM layer; and
a first current line configured to apply current through a first electrode of the electrodes, to the SOT layer, to a second electrode of the electrodes; and
a controller configured to store at least one corresponding weight of an n×m array of weights of a neural network in each of the SOT cell.

2. The DNN device of claim 1, wherein the SOT layer comprises BiSb, YPtBi, FeSi, or CoSi.

3. The DNN device of claim 1, wherein the FM layer has a plurality of cutting notches, so that at least one cutting notch separates a domain from another adjacent domain.

4. The DNN device of claim 1, wherein the FM layer comprises a first surface and a second surface, the first and second surfaces being zigzagged.

5. The DNN device of claim 1, further comprising a tunnel barrier layer on the FM layer, a second FM layer on the tunnel barrier layer, wherein the FM layer, the tunnel barrier layer and the second FM layer form a magnetic tunnel junction and a magnetic state of the FM layer is read via a magneto-resistive effect.

6. The DNN device of claim 1, further comprising a transistor coupled to the SOT cell for applying an input voltage flowing perpendicular to a plane of the SOT layer and FM layer, wherein a magnetic state of the FM layer is read via the inverse spin Hall effect.

7. The DNN device of claim 1, wherein a magnetic state of the FM layer is read via the direct spin Hall effect, where an input current is driven between the first and second electrodes in a plane of the SOT layer.

8. The DNN device of claim 1, wherein the controller is further configured to use a magnetic state of each of a plurality of domains of the FM layer to encode a multi-state weight value having three or more states.

9. A deep neural network (DNN) device, the DNN device comprising:
an array comprising n rows and m columns of nodes, each row of nodes coupled to one of n first conductive lines, each column of nodes coupled to one of m second conductive lines, each node of the n rows and m columns of nodes comprising a plurality of spin-orbit torque (SOT) cells, each SOT cell comprising:
a first ferromagnetic (FM) layer;
a SOT layer disposed on the first FM layer;
a second FM layer disposed on the SOT layer; and
electrodes disposed adjacent to the SOT layer, the electrodes being spaced from the first and second FM layers; and
a controller configured to store at least one corresponding weight of an n×m array of weights of a neural network in each of the SOT cell.

10. The DNN device of claim 9, wherein at least one of the first FM layer or the second FM layer has a multi-elliptical shape creating two or more states, wherein each state of the two or more states is configured to have a weight value.

11. The DNN device of claim 9, wherein at least one of the first FM layer or the second FM layer FM layer has a plurality of cutting notches, so that at least one cutting notch separates a domain from another adjacent domain.

12. The DNN device of claim 9, wherein at least one of the first FM layer or the second FM layer FM layer comprises a first surface and a second surface, the first and second surfaces being zigzagged.

13. The DNN device of claim 9, wherein the first FM layer and the second FM layer comprise different materials.

14. The DNN device of claim 13, wherein the first FM layer comprises CoFe, NiFe, CoFeB, CoB, CoHf, or a combination thereof, and wherein the second FM layer comprises CoFePt, CoPt, CoPtCrB, or a combination thereof.

15. The DNN device of claim 9, wherein the first FM layer has a higher coercivity than the second FM layer.

16. The DNN device of claim 9, wherein the controller is further configured to use a magnetic state of the first FM layer and a magnetic state of the second FM layer to encode a multi-state weight value having three or more states.

17. A deep neural network (DNN) device, the DNN device comprising:
an array comprising n rows and m columns of nodes, each row of nodes coupled to one of n first conductive lines, each column of nodes coupled to one of m second conductive lines, each node of the n rows and m columns of nodes comprising a plurality of spin-orbit torque (SOT) cells, each SOT cell comprising:
a first SOT layer;
a first ferromagnetic (FM) layer disposed on the first SOT layer, the first FM layer having a multi-elliptical shape creating two or more magnetic states at two or more corners or two or more arms formed by the multi-elliptical shape; and
a current input configured to apply a current through: a first current path across the first SOT layer and a second current path across the first SOT layer; and
a controller configured to store at least one corresponding weight of an n×m array of weights of a neural network in each of the SOT cell.

18. The DNN device of claim 17, further comprising:
a second FM layer;
a second SOT layer; and
a third FM layer.

19. The DNN device of claim 18, wherein the first, second, and third FM layer each comprises a different material, and wherein the first, second, and third FM layer each comprises a material selected from the group consisting of: CoFe, NiFe, CoFeB, CoB, CoHf, CoFePt, CoPt, CoPtCrB, or a combination thereof.

20. The DNN device of claim 18, wherein one or more of the second FM layer and the third FM layer has a multi-elliptical shape creating two or more magnetic states at two or more corners or two or more arms formed by the multi-elliptical shape.

21. The DNN device of claim 17, wherein the first and second current paths are perpendicular to each other.
